(19) United States
(12) Patent Application Publication
(10) Pub. No.: US 2024/0308053 A1
(43) Pub. Date: Sep. 19, 2024

(54) INTERCHANGEABLE TOOL ATTACHMENT AND SYSTEM

(71) Applicant: MILWAUKEE ELECTRIC TOOL CORPORATION, Brookfield, WI (US)

(72) Inventors: Ryan E. McKernan, Milwaukee, WI (US); Casey D. Garces, Milwaukee, WI (US); Adam F. Czerwonka, Mukwonago, WI (US); Nathaniel A. Herrera, Oak Creek, WI (US); Shane McCue, Greenfield, WI (US); Shu Rui Liao, Dongguan City (CN); Wei Xiao, Dongguan City (CN); Zhong Xiang Lin, Dongguan City (CN)

(21) Appl. No.: 18/681,200

(22) PCT Filed: Aug. 17, 2022
(86) PCT No.: PCT/US2022/040614

§ 371 Date: Feb. 5, 2024

(30) Foreign Application Priority Data
Aug. 20, 2021 (CN) 202121976929.X

(51) Int. Cl. B25G 3/04; A01B 1/06; A01G 3/053

(52) U.S. Cl. CPC B25G 3/04; A01B 1/065; A01G 3/053

(57) ABSTRACT

A cultivator tool includes a power head having a handle and a user interface. A motor is positioned within the power head and is configured to rotate a drive shaft about a drive axis. The cultivator further includes an attachment stem removably coupled to the power head at a first end and removably supporting a tool attachment unit at an opposite second end. A cover is receivable on the attachment stem between the tool attachment unit and the power head to cover a cutter rotatably supported on the tool attachment unit. The cover includes an aperture configured to receive a projection extending from the stem to limit rotation and sliding of the cover relative the tool attachment unit.

### FIELD OF THE INVENTION

The present invention relates to powered devices, and more particularly, to interchangeable tool attachment units, such as a detachable cultivator, for use with a common power head.

### BACKGROUND OF THE INVENTION

Powered devices, such as outdoor tools (e.g., a trimmer, an edger, a pole saw, etc.), power tools, etc., may include an elongated shaft assembly extending between a power head and a powered attachment unit. For example, cultivators are often used for agitating or loosening ground, especially to improve ease of planting a seed or crop. Cultivators include a tine assembly positioned at an end of an elongated shaft assembly housing a transmission shaft therein. The tine assembly is often driven by a drive shaft that receives input from the transmission shaft. In some instances, the transmission shaft is fixedly coupled to the output shaft of a drive motor positioned within a power head. In other instances, the power head is configured to selectively receive the transmission shaft of the cultivator or another tool attachment unit, such as a weed trimmer. Such tool attachment units may include covers for protecting a user.

### SUMMARY OF THE INVENTION

The present invention provides, in one aspect, an outdoor power tool including a power head including a handle and a user interface, a motor positioned within the power head, an attachment stem removably coupled to the power head and attachable thereon at a first end, a transmission shaft positioned within the attachment stem and configured to rotate in response to rotation of the output shaft, a drive shaft rotatable about a drive axis in response to rotation of the transmission shaft, a transmission supporting a geared connection between the transmission shaft and the drive shaft, a tool attachment unit supported by the attachment stem at a second end thereof, and a cover receivable on the attachment stem between the tool attachment unit and the power head, the cover including an aperture. The motor is rotatable in response to the user interface to rotate an output shaft extending therefrom. The tool attachment unit includes a cutter supported for co-rotation with the drive shaft. At least one of the attachment stem and the tool attachment unit include a projection extending therefrom for engagement with the aperture.

The present invention provides, in another aspect, an outdoor power tool including a motor positioned within a power head and configured to rotate a transmission shaft positioned within an elongated stem, a drive shaft rotatable about a drive axis in response to rotation of the transmission shaft, a coupler mounted to the drive shaft for relative co-rotation therewith, and a cutter configured for relative free rotation with the drive shaft, the cutter attachable with the coupler by a fastener for relative co-rotation with the coupler. The cutter includes a raised boss portion extending from the cutter in a first direction parallel to the drive axis and a depressed portion extending into the cutter in a second direction parallel to the drive axis and generally opposite the first direction. The raised boss portion and the depressed portion provide a clearance between an outer radial surface of the coupler and a side wall formed by the raised boss portion and the depressed portion.

The present invention provides, in still another independent aspect, an outdoor power tool configured to be selectively attached to a power head that includes an elongated stem including a first end and a second end opposite the first end. The elongated stem supports a projection adjacent at least one of the first end and the second end. The outdoor power tool further includes a tool attachment unit supported on the first end of the elongated stem, and a storage attachment removably coupled to a second end of the elongated stem. The storage attachment includes a bayonet slot engageable with the projection such that the storage attachment is moveable between a first position in which the storage attachment is locked to the elongated stem and a second position in which the storage attachment is removable from the elongated stem. The storage attachment is configured to support the outdoor power tool while in the first position.

Other features and aspects of the invention will become apparent by consideration of the following detailed description and accompanying drawings.

### BRIEF DESCRIPTION OF THE DRAWINGS

FIG. 1 is a perspective view of tool system including multiple tool attachments, according to an embodiment of the invention.

FIG. 2A is a lower perspective view of a tool attachment of the tool system of FIG. 1.

FIG. 2B is an enlarged partial perspective view of cover and stem portion of the tool attachment of FIG. 2A.

FIG. 3A is a front cross-sectional view of the tool attachment of FIG. 2A.

FIG. 3B is an enlarged front cross-sectional view of a portion of the tool attachment of FIG. 2A.

FIG. 3C is a side cross-sectional view of the tool attachment of FIG. 2A.

FIG. 3D is a side perspective view of a portion of a cutter.

FIG. 4A is a perspective view of a storage attachment member.

FIG. 4B is a perspective view of a stem portion shaped to receive a portion of the storage attachment member of FIG. 4A.

FIG. 4C is a lower perspective view the storage attachment member of FIG. 4A illustrating an alignment slot.

FIG. 4D is an enlarged isolated view of the alignment slot of FIG. 4C.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

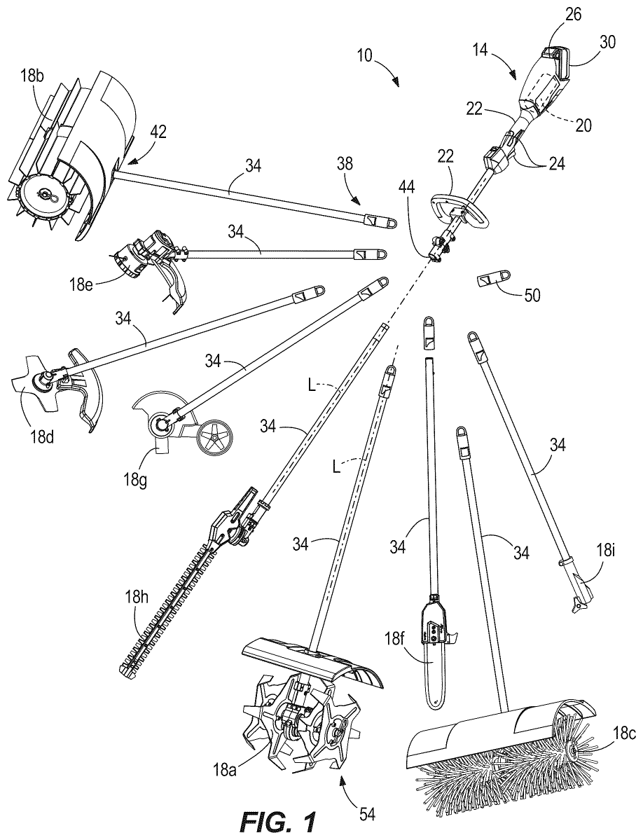

FIG. 1 illustrates an outdoor power tool system 10 including a power head 14 and a plurality of power tool attachments 18 (i.e., outdoor power tools) interchangeably attached to the power head 14. The plurality of tool attachments 18 may consist of, but are not limited to, a cultivator 18a, a rubber broom 18b, a bristle brush 18c, a brush cutter 18d, a string trimmer 18c, a pole saw 18f, an edger 18g, an articulating hedge trimmer 18h, and an extender 18i. Each of the tool attachments 18 may be compatible with the Milwaukee Quik-Lok multi-head power tool system commercialized by Milwaukee Tool.

With continued reference to FIG. 1, the power head 14 includes a motor 20 positioned therein, one or more handles 22 one of which at least partially supporting a user interface 24, and a battery pack interface defining a receptacle 26 that receives a battery pack 30 to power the power head 14. The battery pack 30 provides direct current (DC) power to the motor 20 and the power head 14. The battery pack 30 further includes a latching mechanism to secure the battery pack 30 within the receptacle 26 on the power head 14.

The power head 14 may also include a power inlet to connect the motor 20 to an AC power source, such as a wall outlet or generator, to power the power head 14. The battery pack 30 may be a power tool battery pack 30 generally used to power a power tool, such as an electric drill, an electric saw, and the like (e.g., an 18 volt rechargeable battery pack 30, or an M18 REDLITHIUM battery pack 30 sold by Milwaukee Electric Tool Corporation).

The battery pack 30 may include lithium ion (Li-ion) cells. In alternate embodiments, the battery packs may be of a different chemistry (e.g., nickel-cadmium (NiCa or NiCad), nickel-hydride, and the like). In the illustrated embodiments, the battery pack 30 is an 18 volt battery pack 30. In alternate embodiments, the capacity of the battery pack may vary (e.g., the battery pack may be a 4 volt battery pack, a 28 volt battery pack, a 40 volt battery pack, or battery pack of any other voltage). The battery pack may further include an indicator to display the current state of charge of the battery pack and/or other characteristics of the battery pack.

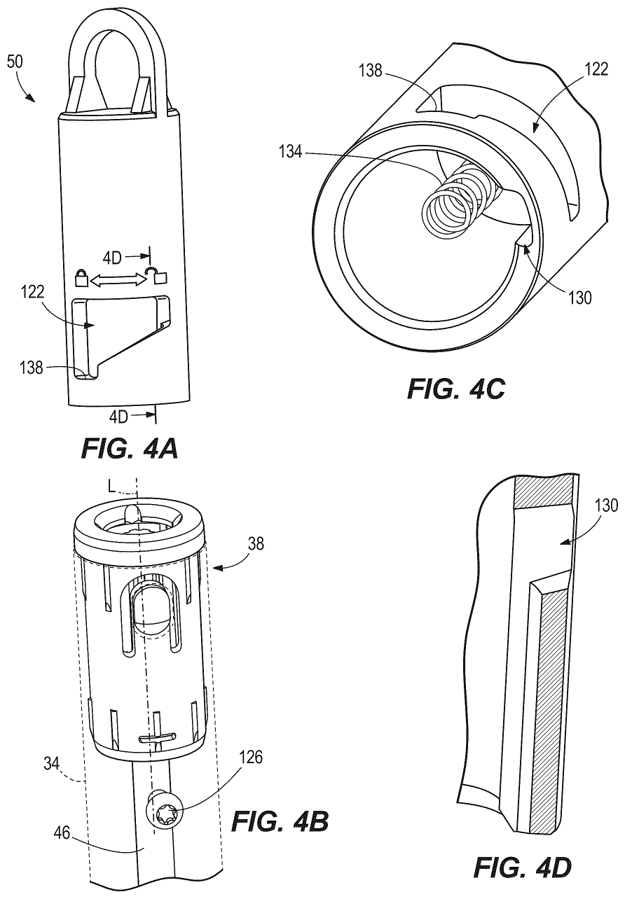

Each of the tool attachments 18 includes an attachment stem or rod 34 removably coupled to the power head 14 at a first end 38 and supporting a tool head or tool attachment unit 54 at a second end 42. The motor 20 positioned in the power head 14 is operable in response to the user interface 24 to rotate an output shaft 44, which imparts rotation on a transmission shaft 46 positioned within the stem 34 such that the transmission shaft 46 is rotatable in response to rotation of the output shaft 44. The output shaft 44 and transmission shaft 46 (FIG. 4B) are generally aligned to rotate about a longitudinal axis L defined along a length of the stem 34. As will be described in greater detail below, the stem 34 of each tool attachment 18 may also selectively receive a storage attachment 50 configured to support the tool attachments 18 while not in use.

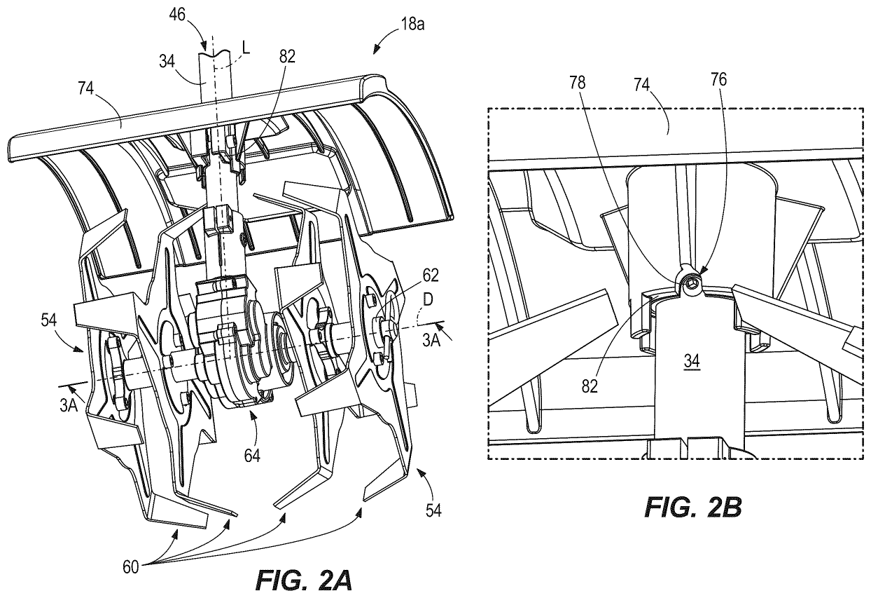

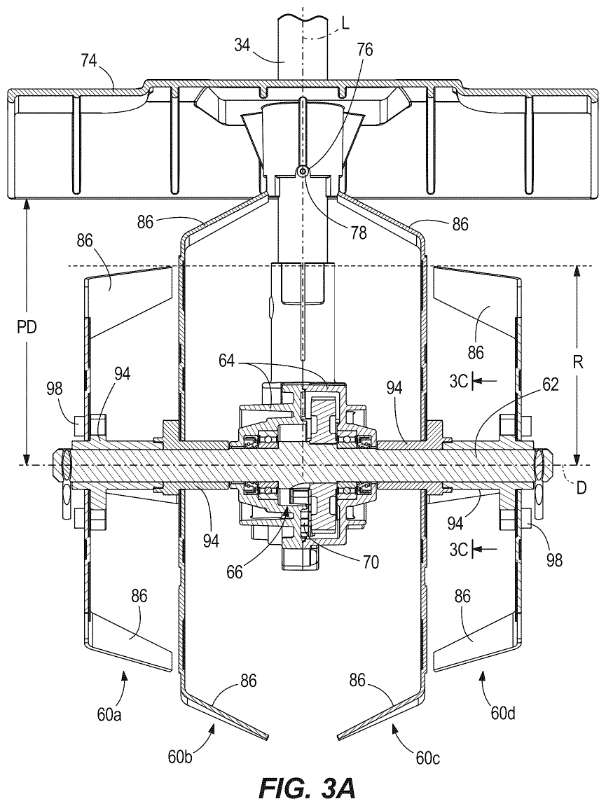

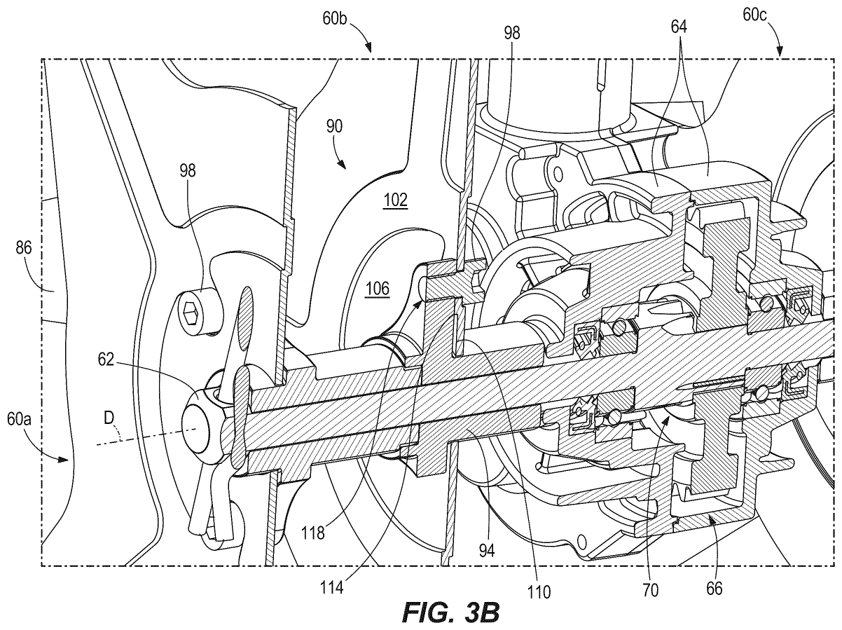

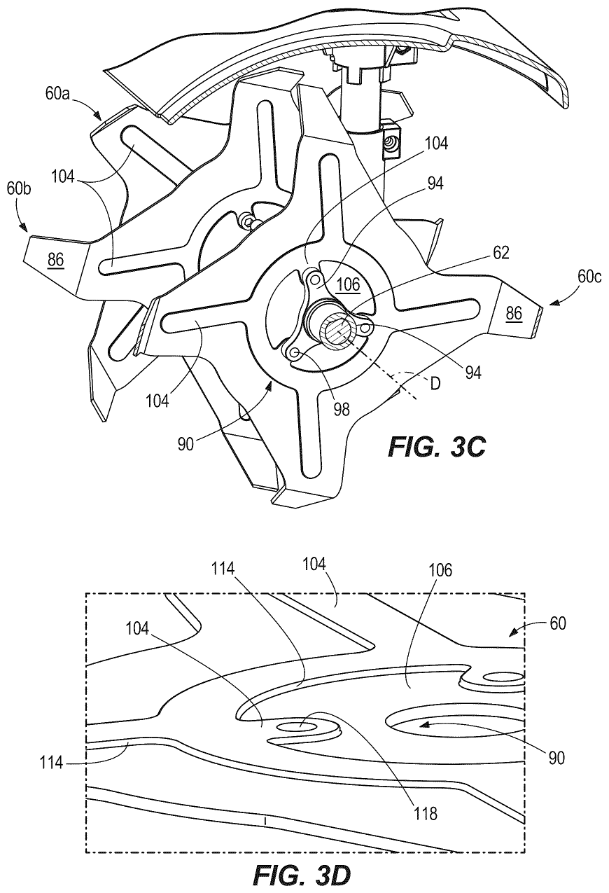

Referring now to FIGS. 2A-3B, the cultivator power tool attachment 18a includes a tool attachment unit 54 supported at the second end 42 of the stem 34. The tool attachment unit 54 includes a cutting assembly 58 having a plurality of blades or tines 60 that are configured for agitating, cultivating, and/or unearthing soil. Each of the blades 60 is generally supported on a drive shaft 62 positioned in the tool attachment unit 54 and driven about a drive axis D in response to rotation of the transmission shaft 46. That is, the tool attachment unit 54 includes a casing 64 supporting a transmission 66 having a gear connection/gear train 70 (FIGS. 3A and 3B) that accommodates a connection between the transmission shaft 46 and the drive shaft 62. In general, the transmission 66 converts rotation of the transmission shaft 46 about the longitudinal axis L to rotation of the drive shaft 62 about the drive axis D such that the tool attachment unit 54 is operated in response to the user interface 24 being selectively operated to energize the motor 20.

Referring specifically to FIGS. 2A and 2B, the cultivator 18a further includes a cover or shield 74 receivable on the attachment stem 34 between the tool attachment unit 54 and the power head 14. In the illustrated embodiment, the cover 74 is positioned on the stem 34 but could be positioned directly on the tool attachment unit 54. As shown in FIG. 2B, the cover 74 is positionable on the stem 34 and includes an aperture or slot or recess 76 that is shaped to receive a projection 78 on the stem 34. The projection 78 may be a screw or knob supported on the stem 34 at a predetermined distance PD (FIG. 3A) away from the drive axis D in order to inhibit the cover 74 from traversing the predetermined distance PD along the longitudinal axis L and contacting the blades 60.

The cover 74 further includes a retention mechanism such as a clamp 82 (FIG. 2A) selectively closed to limit an amount the cover 74 may move relative the blades 60 along the longitudinal axis L. The clamp 82 mainly secures the cover 74 in a position along the longitudinal axis L against the projection 78 while engagement between the projection 78 and the aperture 76 limits movement of the cover 74 along the longitudinal axis L but also inhibits rotation of the cover 74 about the longitudinal axis L relative the tines 60.

In other example embodiments or constructions, such as for the rubber broom 18b or the bristle brush 18c, the cover 74 may also be placed and secured on the stem 34 over a plurality of stiff bristles configured to clear a surface or a plurality of cleaning flaps.

Referring now to FIGS. 3A-3D, the cutting assembly 58 includes four blades or tines 60a, 60b, 60c, 60d positioned along the drive shaft 62. In other embodiments, the cutting assembly 58 includes a greater or lesser number of blades/tines, such as two or six. In the illustrated embodiment, each of the tines 60 includes teeth 86 extending from a base portion 90 of the tine 60 at an angle offset relative the drive axis D. As best illustrated in FIG. 2A, two of the tines 60 (e.g., tine 60a and tine 60d) are positioned outwardly on the drive shaft 62 relative the remaining two of the tines 60 (e.g., tine 60b and tine 60c). The teeth 86 on the outwardly positioned tines 60a, 60d each extend inwardly toward the transmission 66 while the teeth 86 on the inwardly positioned tines 60b, 60c extend. In some embodiments, the teeth 86 on each tine 60 extend in a common direction or commonly extend in alternating directions such that each tine 60 is substantially identical.

With specific reference to FIG. 3A, the tines 60 have an overall radius R defined from the drive axis D and an end of the teeth 86. In the illustrated embodiment, the cover 74 has a curved profile similar to a curved path traveled by the teeth 86. The curved profile of the cover 74 is also offset from the drive axis D due to the cover 74 being constrained from moving within the predetermined distance PD. In the illustrated embodiment, the projection 78 is positioned on the attachment stem 34 the predetermined distance PD away from the drive axis D along the longitudinal axis L, and the predetermined distance PD is greater than the radius R of the tines 60 such that the projection 78 is received in the aperture 76 to inhibit the cover 74 from traversing the predetermined distance PD and contacting the blades 60. In other words, the projection 78 contacts the aperture 76 on the cover 74 to prevent the cover 74 from contacting the blades 60.

Referring now to FIGS. 3A-3D, one or more couplers 94 are mounted to the drive shaft 62 for relative co-rotation therewith for communicating rotation to the tines 60. As best illustrated in FIG. 3C, an outer radial surface of the drive shaft 62 has a generally D-shaped cross section, and an inner radial surface of the coupler 94 has a complimentary generally D-shaped cross section. An inner radial surface of the tines 60 is generally circular such that the tines 60 will not rigidly rotate (e.g., free rotation) with the drive shaft 62. In other words, the tines 60 are configured for relative free rotation with the drive shaft 62. To rotate the tines 60, at least one of the couplers 94 is attached to each tine 60 by a fastener 98 such that each tine 60 becomes rigidly attached to a corresponding coupler 94. The couplers 94 further provide for proper spacing of the couplers 94 and tines 60 along the drive shaft 62.

With reference to FIGS. 3B-3D, each tine 60 includes a raised boss portion 102 extending from the base portion 90 of the tine 60 in a first direction parallel to the drive axis D and a depressed portion 106 extending into the tine 60 in a second direction parallel to the drive axis D and generally opposite the first direction. As best illustrated in FIG. 3B, the raised boss portion 102 and the depressed portion 106 provide a clearance 110 between an outer radial surface of the coupler and a side wall 114 formed by the raised boss portion 102 and the depressed portion 106. In the illustrated embodiment, each tine 60 includes a through hole 118 configured to receive the fastener 98. The through hole 118 may extend through a portion of the tine 60 adjacent the raised boss portion 102 and the depressed portion 106 such that the gap/clearance 110 is formed between the fastener 98 and the outer surface of the coupler 94. By providing such a gap 110, an overall strength of the tine 60 may be increased.

With brief reference to FIGS. 3C and 3D, the complimentary D-shaped cross-section of the drive shaft 62 outer surface and the inner surface of the couplers 94 drives co-rotation between the drive shaft 62 and the couplers 94. As also illustrated in FIG. 3C, the curved profile of the cover 74 may be sufficiently distanced from the tines 60 and bent or curved relative the drive axis D.

Referring now to FIGS. 4A-4D, the storage attachment 50 configured to support the tool attachments 18 while not in use will now be described in greater detail. The storage attachment 50 may be a hook or clip 50 removably coupled to the second end 42 of the stem 34 to store the tool attachment 18 on a mount (e.g., wall hook) while not attached to the power head 14. In the illustrated embodiment, the storage attachment 50 and the power head 14 are each interchangeably/selectively attached to the same end of the stem 34 (i.e., second end 42).

The storage attachment 50 includes a bayonet slot 122 engageable with a projection 126 extending from the stem 34. The bayonet slot 122 extends radially around a portion of the storage attachment 50. The storage attachment 50 is moveable relative the stem 34 between a first position in which the storage attachment 50 is locked to the elongated stem 34 and a second position in which the storage attachment 50 is removable from the elongated stem 34. The storage attachment 50 is configured to support the outdoor power tool attachment 18 while in the first position.

The storage attachment 50 further includes a clearance slot 130 extending axially (e.g., along the longitudinal axis L) along a portion of the storage attachment 50 to accommodate removal of the projection 126 through the clearance slot 130. A biasing member 134 may be positioned in the attachment 50 to bias the storage attachment 50 toward the first position. As illustrated in FIG. 4A, the bayonet slot 130 is sloped between the clearance slot 130 and an indent 138 formed in the bayonet slot 130. In order to remove the stem 34 from the storage attachment 50, a force may be applied to the storage attachment 50 to overcome the biasing force after which the storage attachment 50 may be rotated relative the stem 34 and the projection 126 may be removed through the clearance slot 134. When attaching the storage attachment 50 to the stem 18, the biasing force assists in biasing the storage attachment 50 to the locked position. The storage attachment 50 may be used with any of the cultivator 18a, the rubber broom 18b, the bristle brush 18c, the brush cutter 18d, the string trimmer 18e, the pole saw 18f, the edger 18g, the articulating hedge trimmer 18h, and the extender 18i.

Various features of the invention are set forth in the following claims.

What is claimed is:

1. An outdoor power tool comprising:
a power head including a handle and a user interface;
a motor positioned within the power head, the motor rotatable in response to the user interface to rotate an output shaft extending therefrom;
an attachment stem removably coupled to the power head and attachable thereon at a first end;
a transmission shaft positioned within the attachment stem and configured to rotate in response to rotation of the output shaft;
a drive shaft rotatable about a drive axis in response to rotation of the transmission shaft;
a transmission supporting a geared connection between the transmission shaft and the drive shaft;
a tool attachment unit supported by the attachment stem at a second end thereof, the tool attachment unit including a cutter supported for co-rotation with the drive shaft; and
a cover receivable on the attachment stem between the tool attachment unit and the power head, the cover including an aperture;
wherein at least one of the attachment stem and the tool attachment unit include a projection extending therefrom for engagement with the aperture.

2. The outdoor power tool of claim 1, wherein the tool attachment unit is a tine assembly configured to cultivate soil.

3. The outdoor power tool of claim 1, wherein the motor is battery operated.

4. The outdoor power tool of claim 1, wherein a length of the attachment stem defines a longitudinal axis about which the transmission shaft rotates, and wherein the cover further includes a retention mechanism selectively closed to limit an amount the cover may move relative the cutter along the longitudinal axis.

5. The outdoor power tool of claim 4, wherein the cutter is a first blade in a plurality of blades each rotatable about the drive axis, wherein at least one of the plurality of blades has a first radius.

6. The outdoor power tool of claim 5, wherein the projection is positioned on the attachment stem a predetermined distance away from the drive axis along the longitudinal axis, and wherein the projection is received in the aperture to inhibit the cover from traversing the predetermined distance and thereby contacting the plurality of blades.

7. The outdoor power tool of claim 6, wherein the predetermined distance is greater than the first radius.

8. The outdoor power tool of claim 4, wherein the projection is receivable in the aperture along the longitudinal axis to inhibit rotation of the cover about the longitudinal axis.

9. The outdoor power tool of claim 4, wherein the projection is a screw and the aperture is a slotted recess, and wherein the screw is receivable in the slotted recess along the longitudinal axis to inhibit rotation of the cover about the longitudinal axis and limit movement of the cover along the longitudinal axis.

10. The outdoor power tool of claim 1, wherein the tool attachment unit includes a plurality of stiff bristles configured to clear a surface.

11. The outdoor power tool of claim 1 further comprising a plurality of differently configured tool attachment units each selectively supported by the attachment stem, and wherein the plurality of differently configured tool attachment units includes at least two of a cultivator, a brush, bristles, a trimmer, and a saw.

12. An outdoor power tool comprising:
a motor positioned within a power head and configured to rotate a transmission shaft positioned within an elongated stem;
a drive shaft rotatable about a drive axis in response to rotation of the transmission shaft;
a coupler mounted to the drive shaft for relative co-rotation therewith; and
a cutter configured for relative free rotation with the drive shaft, the cutter attachable with the coupler by a fastener for relative co-rotation with the coupler;
wherein the cutter includes a raised boss portion extending from the cutter in a first direction parallel to the drive axis and a depressed portion extending into the cutter in a second direction parallel to the drive axis and generally opposite the first direction; and
wherein the raised boss portion and the depressed portion provide a clearance between an outer radial surface of the coupler and a side wall formed by the raised boss portion and the depressed portion.

13. The outdoor power tool of claim 12, wherein an outer radial surface of the drive shaft has a generally D-shaped cross section, and wherein an inner radial surface of the coupler has a complimentary generally D-shaped cross section.

14. The outdoor power tool of claim 12, wherein the cutter further includes a through hole configured to receive the fastener, and wherein the through hole extends through a portion of the cutter adjacent the raised boss portion and the depressed portion.

15. An outdoor power tool configured to be selectively attached to a power head, the outdoor power tool comprising:
an elongated stem including a first end and a second end opposite the first end, the elongated stem supporting a projection adjacent at least one of the first end and the second end;
a tool attachment unit supported on the first end of the elongated stem; and
a storage attachment removably coupled to a second end of the elongated stem;
wherein the storage attachment includes a bayonet slot engageable with the projection such that the storage attachment is moveable between a first position in which the storage attachment is locked to the elongated stem and a second position in which the storage attachment is removable from the elongated stem; and
wherein the storage attachment is configured to support the outdoor power tool while in the first position.

16. The outdoor power tool of claim 15, wherein the storage attachment and the power head are both selectively attachable to the same end of the elongated shaft.

17. The outdoor power tool of claim 15, wherein the bayonet slot extends radially around a portion of the storage attachment, and wherein the storage attachment further includes a clearance slot extending axially along a portion of the storage attachment to accommodate removal of the projection through the clearance slot.

18. The outdoor power tool of claim 15, wherein the storage attachment is biased toward the first position by a biasing member.

19. The outdoor power tool of claim 15, wherein the tool attachment unit is any one of a cultivator tool attachment unit, a brush tool attachment unit, a plurality of bristles tool attachment unit, a trimmer tool attachment unit, an edger tool attachment unit, and a saw tool attachment unit.

20. The outdoor power tool of claim 19, wherein the storage attachment is attachable to any number of tool attachment units while not in use with the power head.
